(19) United States
(12) Patent Application Publication
(10) Pub. No.: US 2015/0205940 A1
(43) Pub. Date: Jul. 23, 2015

(54) METHOD FOR CONTROLLING ONLINE PREVIEWING OF E-BOOK PAGE

(71) Applicant: Fujian Foxit Software Development Joint Stock Co., Ltd., Fuzhou (CN)

(72) Inventors: Yuqian Xiong, Fuzhou (CN); Guojia Wang, Fuzhou (CN)

(21) Appl. No.: 14/420,484

(22) PCT Filed: May 21, 2013
(86) PCT No.: PCT/CN2013/000593

§ 371 Date: Feb. 9, 2015

(30) Foreign Application Priority Data
Aug. 9, 2012 (CN) 201210283182.9

(51) Int. Cl. G06F 21/10; G06F 21/60; G06F 17/30

(52) U.S. Cl. CPC G06F 21/10; G06F 17/30091; G06F 21/602; G06F 2221/0742

(57) ABSTRACT

Disclosed is a method for controlling online previewing of an e-book page, comprising the following steps of: encrypting, on a server end, an e-book based on content, and establishing an index file of a relationship between a page number and an encrypted object flow in the encrypted e-book, the index file comprising a page code, an object name, a starting location of the object in the file and the number of bytes of the object; when an encrypted file reader and the server end perform reading handshake, obtaining a range value of previewed page and the index file in advance; according to a range code of the previewed page and the index file, obtaining a data flow of an encrypted object page by page; performing, by the encrypted file reader, integrity verification on object data, and then decrypting, parsing, and displaying information of the preview page.

### TECHNICAL FIELD

The present invention relates to the field of the digital rights management (Digital Rights Management, DRM) technology, in particular, to a method for controlling online previewing page(s) of an e-book (an electronic book).

### BACKGROUND

In the e-book publishing industry, normally, the buyer prefer to read part of the content of the e-book before deciding to purchase, thus electronic book processors have to generate the independent preview file generally for users to download, predicted-reading.

FIG. 1 is a schematic diagram of the method for controlling online previewing an e-book page in correlation techniques; Shown in FIG. 1, for PDF (Portable Document Format, Portable Document Format) files, a commonly used method is to extract one page previewing files from the PDF encrypted file, and to read with the control part the predicted-reading file, but this method can not set the previewed page(s) flexibly and randomly, but take tremendous human cost.

### SUMMARY OF THE INVENTION

The present invention provides a method for controlling online previewing page(s) of an e-book, so as to set the previewed pages randomly and automatically.

In order to achieve the above-mentioned object, the present invention provides a method for controlling online previewing page(s) of an e-book, the method comprising following steps:
encrypting, on a server end, an e-book based on content; and establishing an index file of a relationship between a page number and an encrypted object stream in the encrypted e-book, the index file comprising a page number, an object name, an initial position of the object in the file and the number of byte(s) of the object;

When an encrypted file reader interacts with the server end, the page number value(s) in a range of previewed page(s) and the index file are obtained.

According to the page number value(s) of the range of the previewed page(s) and the correspondence relationship of the index file thereof, the data stream of the encrypted object is obtained.

The encrypted file reader verifies the integrity of the number of the byte(s) of the encrypted data stream, if the verification result is the same as the number of the byte(s) of the object described by the index file, then it decrypts the encrypted data stream, and parses and displays the information of the previewed page(s).

The control method further comprising the following:

Determining whether the information of the previewed page(s) is loaded by the encrypted file reader successfully or not; and

Returning an error message from the server side to the encrypted file reader, and the loading a failure message displayed by the encrypted file reader, and etc.;

Based on the above mentioned, a PDF file is most appropriate for current e-books.

By means of the method for controlling online previewing the pages of the encrypted files in the embodiments above, it is flexible and random to set the previewed pages. And different readers read the content of different page ranges of the same encrypted file online in different time without modifying the encrypted e-book. Therefore, the cost of the manpower, the storage space and the system information maintenance of the e-book sellers are reduced.

### DESCRIPTION OF THE DRAWINGS

In order to more clearly illustrate the present invention embodiment or the technical solution in the art, the attached drawings, which need be applied in the present invention embodiment or the technical description in the art, will be introduced briefly as following, Apparently the attached drawings in the following descriptions only are some embodiments of the present invention. As those skilled in the art need not pay any creative work, other drawings are also obtained based on these attached drawings.

FIG. 1 is a schematic diagram of the method for controlling previewing pages of the electronic book in related art;

FIG. 2 is a schematic diagram of an embodiment of the method for controlling online previewing page(s) of an e-book to the present invention.

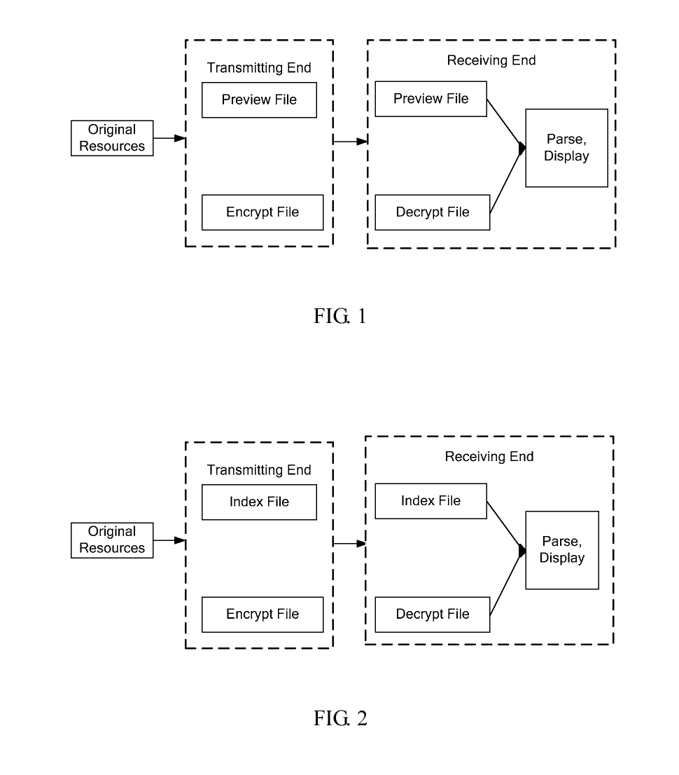

### DETAILED DESCRIPTION OF THE EMBODIMENTS

With reference to the accompanying drawings in the embodiments of the present invent, the description of the technical proposal of embodiments of the present invention is given clearly and integrality as following. The given embodiments are only part of the embodiments to the present invention obviously, but not entire embodiments. Based on the embodiments of the present invention, all of the other embodiments which are got without devoting a creative work by those skilled in the art should be deemed to fall within the scope of the present invention.

FIG. 2 is a schematic diagram of an embodiment of the method for controlling online previewing page(s) of an e-book to the present invention. As shown in the FIG. 2, it comprises the following steps:

S102, The e-book is encrypted based on the content object on the server side (transmitting end), and an index file is established with a relationship between a page number, an object name, an initial position of the object in the file and the number of the byte(s) of the object in the encrypted e-book;

S104, When an encrypted file reader (receiving end) interacts with the server end, the page number value(s) in a range of previewed page(s) and the index file are obtained.

S106, According to the page number value(s) of the range of the previewed page(s) and the correspondence relationship of the index file thereof, the data stream of the encrypted object is obtained.

S108, The encrypted file reader verifies the length number integrity of the encrypted data stream within the corresponding range in advance, and then parses and displays the information of the previewed pages after passing the verification.

For example, in the control method, the page number value(s) of the range of the previewed page(s) is obtained randomly while the encrypted file reader and the server side perform a handshake.

In addition, in order to remind users an error message timely when the encrypted file reader is loading the previewed pages, the control method further comprises following steps:

Determining whether the information of the previewed page(s) is loaded by the encrypted file reader successfully or not; and

Returning an error message from the server side to the encrypted file reader, so as to respond if the previewed page(s) has not been loaded successfully by the encrypted file reader;

For example, the e-book above is a PDF file.

By means of the method of online previewing the pages of the encrypted files in the embodiments above, it is flexible and random to set the previewed pages. And the different readers, who have the right of reading the previewed pages, can read the contents of different pages without modifying the encrypted e-book. And the cost of the manpower of e-book sellers is reduced.

Those skilled in the art will be understood: the drawings are a schematic of an embodiment, the modules or processes in the accompanying drawings, and not necessarily essential to implement the present invention.

This will be understood by those skilled in the art: the module of the apparatus of the embodiment may be distributed in the apparatus of the embodiment according to the description of the embodiment, or may be various to adjust to the corresponding one or more devices too, which are different from the present embodiment. The module of the above embodiment can be combined into one module or may be further split into a plurality of sub-modules.

Finally, it should be noted that: the embodiments above are merely to illustrate the technical aspect of the present invention, but not intended to limit; despite the reference to the aforementioned embodiments of the present invention has been described in detail, those skilled in the art should understand: it is still possible that the technical solution described in the foregoing embodiment is modified, or some technical features are replaced in equivalent; while these modifications or replacements do not essentially corresponding technical solutions departing from the spirit and scope of the invention to implement technical solutions.

1. A method for controlling online previewing an e-book page, comprising:
encrypting, on a server end, an e-book based on the content objects, and establishing an index file of a relationship between a page number and an encrypted object stream in the encrypted e-book, the index file comprising a page number, an object name, an initial position of the object in the file and the number of byte(s) of the object;
When an encrypted file reader interacts with the server end, obtaining the page number value(s) in a range of previewed page(s) and the index file;
According to the page number value(s) of the range of the previewed page(s) and the correspondence relationship of the index file thereof, obtaining the data stream of the encrypted objects;
Determining whether the information of the previewed page(s) is loaded by the encrypted file reader successfully;
Returning an error message from the server side to the encrypted file reader, so as to respond if the encrypted object stream of the previewed page(s) has not been loaded successfully by the encrypted file reader; and
verifying the integrity of the number of the byte(s) of the encrypted data stream by encrypted file reader; if the verification result is the same as the number of the byte(s) of the object described by the index file, then the encrypted data stream is decrypted and parsed, and the information of the previewed page is displayed.

2. The method as claimed in claim 1, wherein the page number value(s) in the range of the previewed pages is obtained when an encrypted file reader and the server side perform a handshake.

3. (canceled)

4. The method as claimed in claim 1, wherein the electronic book is a PDF file.

5. The method as claimed in claim 2, wherein the electronic book is a PDF file.
